(19) United States
(12) Patent Application Publication
(10) Pub. No.: US 2021/0302024 A1
(43) Pub. Date: Sep. 30, 2021

(54) AUTOMATIC SMOKELESS OVEN WITH FAR INFRARED HEATING

(71) Applicant: Ho Kai Chan, Hong Kong (HK)

(72) Inventor: Ho Kai Chan, Hong Kong (HK)

(21) Appl. No.: 17/145,620

(22) Filed: Jan. 11, 2021

(30) Foreign Application Priority Data
Mar. 24, 2020 (CN) 202010213447.2

(51) Int. Cl. F24C 1/08; A47J 37/04; B01D 47/02; B01D 53/02; F27D 9/00; F24C 15/20

(52) U.S. Cl. CPC F24C 1/08; A47J 37/044; B01D 47/02; F27D 2009/0013; F27D 9/00; F24C 15/2042; B01D 2253/102; B01D 53/02

(57) ABSTRACT

The disclosure provides an automatic smokeless oven with far infrared heating including a seat body, a rotating device, an air treatment device and a cooling device. The infrared heater is positioned above a first cavity and used for heating the first cavity so as to prevent grease, sauce and the like from contacting a heating source to generate oily smoke. The rotating device is arranged in a second cavity and used for driving the food to be baked to turn over, so as to realize an automatically turning over of the food. The air treatment device is arranged at the bottom of the first cavity and used for filtering the air in the first cavity to further reduce smoke emission. The cooling device is arranged at the bottom of the first cavity and communicated with the third cavity for driving the cooling water to flow through the third cavity.

### CROSS-REFERENCE TO RELATED APPLICATIONS

This application claims priority to Chinese Patent Application No. 202010213447.2 with a filing date of Mar. 24, 2020. The content of the aforementioned applications, including any intervening amendments thereto, are incorporated herein by reference.

### TECHNICAL FIELD

The disclosure relates to the technical field of a smokeless oven, in particular to an automatic smokeless oven with far infrared heating.

### BACKGROUND ART

A common oven includes a carbon oven, a gas oven and an electric oven. In the carbon oven, heat to be required is usually generated by burning wood or charcoal placed at a bottom of the oven, but because the wood or charcoal is not completely burned or contains certain impurities, it is easy to generate a large amount of smoke in burning. Meanwhile, there is very little smoke generated by a heating source of the gas oven and the electric oven, but the carbon oven, gas oven, electric oven and microwave oven are usually arranged below baked food. During a baking process, temperature of each part in the oven is high, and grease and sauce seeped from the food easily results in oily smoke when they come into contact with a surface of the heating source or the bottom of the oven.

In addition, the baked food needs frequent manual rotations, which is very troublesome, and a direct emission of smoke generated from barbecue is also harmful to the environment. Therefore, it is necessary to provide an oven which can automatically turn over the food being baked and simultaneously reduce the smoke emission.

In view of this, it is particularly essential to develop and design an automatic smokeless oven with far infrared heating which can solve the above technical problems.

### SUMMARY

A purpose of the disclosure is to provide an automatic smokeless oven with far infrared heating, which presents a reasonable and simple structure, convenient use and less generated oily smoke, and effectively solves a problem that the oily smoke pollutes environment in existing ovens.

The disclosure provides a technical scheme as follows.

In a first aspect, an embodiment of the disclosure provides an automatic smokeless oven with far infrared heating, which includes a seat body, a rotating device, an air treatment device and a cooling device. The seat body is provided with: a first cavity having an opening at a top thereof, a second cavity transversely arranged in the first cavity and having an opening at a top thereof, and a third cavity located at a bottom of the first cavity. An arc plate is also provided above the seat body. The arc plate is formed by extending an edge of the first cavity towards the opening at the top of the first cavity. Baffles are provided between two ends of the arc plate in a first direction and the seat body. The first direction is a longitudinal direction of the seat body. An infrared heater, which is open to the first cavity, is provided at a side surface of the arc plate proximate to the first cavity and is used for heating the first cavity. The rotating device is arranged in the second cavity to drive food to be baked to turn over. The air treatment device is arranged at the bottom of the first cavity and used for filtering air in the first cavity. The cooling device is arranged at the bottom of the first cavity and communicated with the third cavity for driving cooling water to flow through the third cavity.

Combined with the first aspect, in a first implementation of the first aspect, a flipper is hinged at a side of the arc plate away from the first cavity. The flipper, the arc plate and the seat body together enclose a fifth cavity. The arc plate is provided with a plurality of first through holes communicating the fifth cavity with a space above the first cavity. The air treatment device is communicated with the first through holes and can filter the air in the first cavity with the first through holes.

Combined with the first aspect and the above implementation, in a second implementation of the first aspect, a fourth cavity is provided at a bottom of the third cavity. The air treatment device is arranged in the fourth cavity and includes an air pump and a filter box. A sixth cavity and a seventh cavity which are sequentially communicated with each other are provided in the filter box. A first filter is provided in the sixth cavity, and liquid filter media is filled in the sixth cavity. A second filter connected with the sixth cavity is provided in the seventh cavity. An air inlet and outlet of the air pump are respectively communicated with the fifth cavity and the first filter.

Combined with the first aspect and the above-mentioned implementation, in a third implementation of the first aspect, the first filter and the second filter include a third casing and a gas pipeline which are sleeved with each other. An inner cavity of the third casing is filled with activated carbon.

Combined with the first aspect and the above implementation, in a fourth implementation of the first aspect, the rotating device includes a cover plate with a U-shaped structure, a plurality of rollers, a transmission belt and a motor arranged in the second cavity. The cover plate is fixedly arranged on an opening of the second cavity. The rollers are rotatably connected to a side wall of the second cavity, and the roller are in transmission connection with the motor. The transmission belt is sleeved on the roller and used for driving the food to be baked to turn over. A supporting plate corresponding to the second cavity is provided in the first cavity. First serrations are provided on a top of the supporting plate, and second serrations are provided on a side of the cover plate proximate to the supporting plate. Heights of the first serrations are lower than those of the second serrations, and the first serrations and the second serrations are used for jointly bearing two ends of the food to be baked.

Combined with the first aspect and the above-mentioned implementations, in a fifth implementation of the first aspect, a fourth cavity is provided at a bottom of the third cavity, and the cooling device is arranged in the fourth cavity and includes a water tank filled with water, an electromagnetic valve communicated with an inner cavity of the water tank, a water pump provided in the water tank, a water pressure sensor, a radiator, a fan, a controller and a temperature sensor. An outlet of the water pump and the electromagnetic valve are respectively communicated with the third cavity. The radiator includes a connecting plate abutting against a bottom surface of the water tank and a plurality of radiating fins vertically connected with the connecting plate. The fan is connected with the radiating fins.

Combined with the first aspect and the above implementation, in a sixth implementation of the first aspect, both ends of the fourth cavity are provided with openings, and mesh plates are fixedly arranged on the openings.

Combined with the first aspect and the above-mentioned implementation, in a seventh implementation of the first aspect, one side of the infrared heater is hinged with the arc plate, and another side of the infrared heater is provided with a telescopic rod hinged with the arc plate.

Combined with the first aspect and the above implementation, in an eighth implementation of the first aspect, a plurality of hollow cylinders are arranged on a bottom wall of the first cavity, and a flat plate is arranged above the hollow cylinders. A connecting column is arranged on the bottom of the flat plate and sleeved on the hollow cylinder. A plurality of second through holes communicated with the hollow cylinder are arranged on the flat plate, and a plurality of grooves communicated with the through holes are arranged on an upper end face of the flat plate.

Combined with the first aspect and the above-mentioned implementations, in a ninth implementation of the first aspect, a leg is provided at a bottom of the seat body, and the leg is any one of a telescopic rod, a hydraulic cylinder and an electric cylinder, or a combination thereof.

Compared with the prior art, the automatic smokeless oven with far infrared heating provided in the embodiments of the disclosure has following beneficial effects.

The automatic smokeless oven with far infrared heating includes the seat body, the rotating device, the air treatment device and the cooling device. The seat body is provided with: the first cavity having an opening at the top thereof, the second cavity transversely arranged in the first cavity and having the opening at the top thereof, and the third cavity located at the bottom of the first cavity. An arc plate is also provided above the seat body. The arc plate is formed by extending an edge of the first cavity towards the opening at the top of the first cavity. Baffles are provided between two ends of the arc plate in a first direction and the seat body. The first direction is a longitudinal direction of the seat body. An infrared heater, which is open to the first cavity, is provided at a side surface of the arc plate proximate to the first cavity and is used for heating the first cavity, thus heating the food to be baked and reducing the oily smoke. Further, the rotating device is arranged in the second cavity to drive the food to be baked to turn over, so as to realize the automatically turning over of the food. Furthermore, the air treatment device is arranged at the bottom of the first cavity and used for filtering the air in the first cavity to further reduce smoke emission. In addition, the cooling device is arranged at the bottom of the first cavity and communicated with the third cavity for driving the cooling water to flow through the third cavity. In this way, a temperature of the bottom wall of the first cavity can be reduced, and thus there is less probability for generating the oily smoke when grease, sauce and the like contact the bottom wall of the first cavity, due to a lower temperature.

In order to make the above objects, features and advantages of the present disclosure more obvious and easy to understand, a detailed description will be made below to the preferred embodiments in conjunction with the drawings.

### BRIEF DESCRIPTION OF DRAWINGS

In order to explain technical schemes of the embodiments of the present disclosure more clearly, the drawings used in the embodiment will be briefly introduced below. It should be understood that the following drawings only illustrate certain embodiments of the present disclosure, and therefore should not be regarded as limiting the scope thereof. For those skilled in the art, other related drawings can be obtained according to these drawings without paying any creative labor.

FIG. 1 is a schematic structural diagram of a smokeless oven according to an embodiment of the present invention.

FIG. 2 is a schematic sectional view of a smokeless oven according to an embodiment of the present invention.

FIG. 3 is a schematic structural diagram of a part of a smokeless oven according to an embodiment of the present invention.

FIG. 4 is a schematic structural diagram of a flat plate of a smokeless oven according to an embodiment of the present invention.

FIG. 5 is a schematic structural diagram of a cover plate of a smokeless oven according to an embodiment of the present invention.

FIG. 6 is a schematic structural diagram of an air treatment device of a smokeless oven according to an embodiment of the present invention.

FIG. 7 is a schematic structural diagram of a first filter of an air treatment device of a smokeless oven according to an embodiment of the present invention.

FIG. 8 is a structural schematic diagram of a cooling device of a smokeless oven according to an embodiment of the present invention.

FIG. 9 is a structural schematic diagram of a radiator and a fan of a cooling device of a smokeless oven according to an embodiment of the present invention.

Reference number: 1—Seat Body; 100—First Cavity; 101—Hollow Cylinder; 102—Second Cavity; 11—Arc Plate; 111—Infrared Heater; 112—Telescopic Rod; 113—First Through Hole; 114—Flipper; 115—Fifth Cavity; 12—Support Plate; 121—First Serration; 13—Baffle; 14—Mesh Plate; 15—leg; 16—Flat Plate; 161—Groove; 162—Second Through Hole; 163—Connecting Column; 17—Third Cavity; 18—Fourth Cavity; 181—Temperature Sensor; 19—Controller; 2—Rotating Device; 21—Cover Plate; 211—Round Hole; 212—Second Serration; 22—Roller; 23—Transmission Belt; 24—Motor; 3—Air Treatment Device; 31—Filter Box; 32—Sixth Cavity; 33—Seventh Cavity; 34—First Filter; 341—Gas Pipeline; 342—Third Housing; 35—Second Filter; 36—Air Pump; 37—Water Injection Hole; 4—Cooling Device; 41—Water Tank; 42—Electromagnetic Valve; 43—Water Pump; 44—Radiator; 441—Connecting Plate; 442—Radiating Fin; 45—Water Pressure Sensor; 46—Fan.

### DETAILED DESCRIPTION

In order to make the objects, technical schemes and advantages of the embodiments of the present disclosure more clear, the technical schemes in the embodiments of the present disclosure will be described clearly and completely in combination with the drawings in the embodiments of the present disclosure. Obviously, the described embodiments are some, but not all, of the embodiments of the present disclosure. Generally, components of the embodiments of the present disclosure described and illustrated in the drawings herein may be arranged and designed in various different configurations.

It should be noted that similar reference numbers and letters indicate similar items in the following figures, and thus once an item is defined in one figure, it is not necessary to further define and explain it in the following figures. Orientations or positional relationships indicated by the terms “upper”, “lower”, “inner”, “outer”, “left” and “right” or the like are based on orientations or positional relationships shown in the drawings, or orientations or positional relationships that a product of the present disclosure are usually placed in use, or orientations or positional relationships that are commonly understood by those skilled in the art, which is only for convenience of describing the present disclosure and for simplifying the description, but is not intended to indicate or imply that the referenced apparatus or component must be in a particular orientation, configured or operated in a particular orientation, and thus should not to be construed as limiting the present disclosure. The terms “first”, “second”, etc. are only used to distinguish descriptions, and cannot be understood as indicating or implying a relative importance. Terms “comprising”, “including” or any other variation thereof are intended to encompass a non-exclusive inclusion, so that a process, method, article or apparatus including a series of elements includes not only those elements, but also other elements not explicitly listed, or elements inherent to such process, method, article or apparatus. Without further restrictions, an element defined by the statement “includes a . . . ” does not exclude presence of other identical elements in the process, method, article or apparatus including the element.

It should also be noted that unless otherwise specified and limited, terms such as “providing” and “connecting” should be understood in a broad sense. For example, “connecting” can be a connection, a detachable connection, or an integral connection; or can be a mechanical or electrical connection; or can be a direct connection, or an indirect connection through an intermediate medium, or can be a communication inside two components. For a person of ordinary skill in the art, specific meanings of the above terms in the present disclosure can be understood according to specific situations.

The specific embodiments of the present disclosure will be described in detail in combination with the drawings.

### Examples

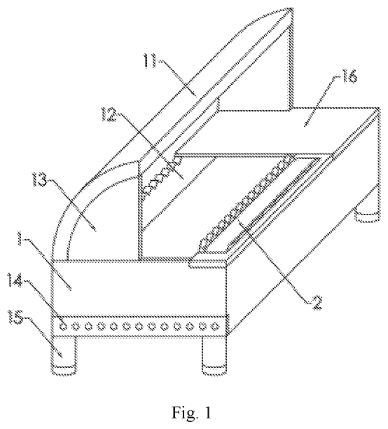

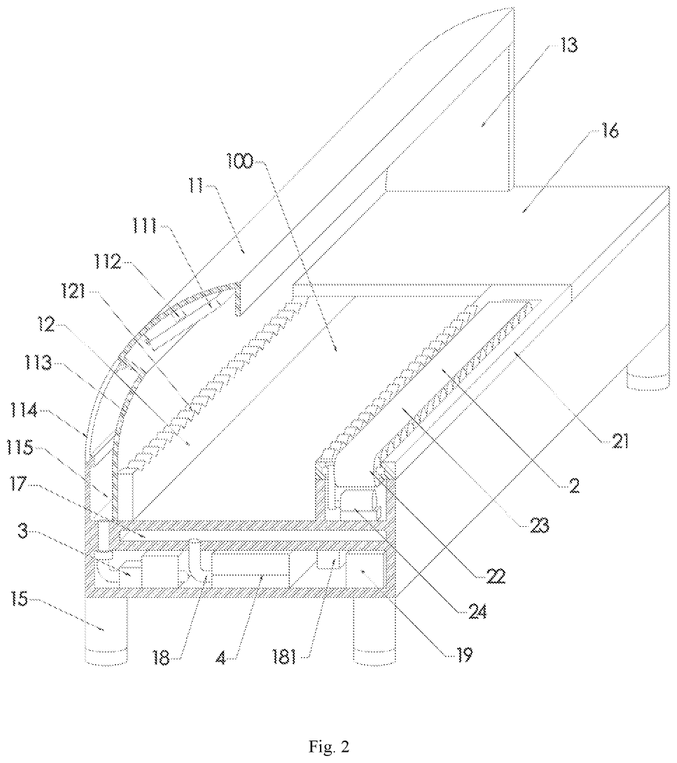

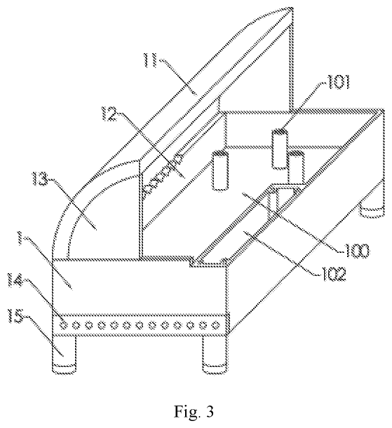

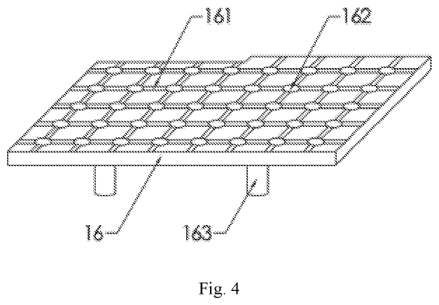

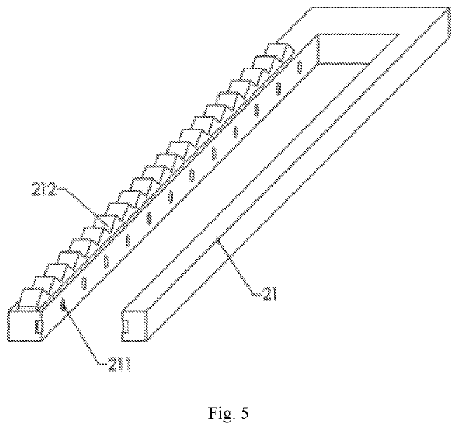

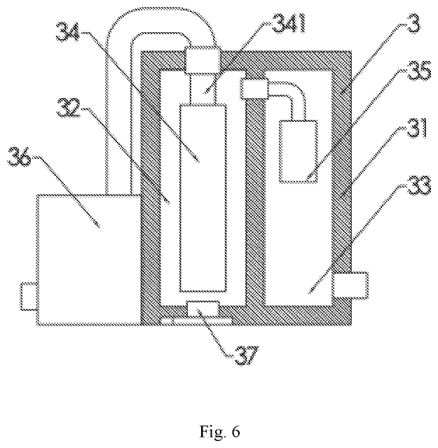

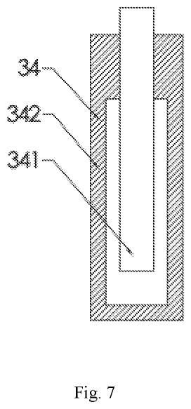

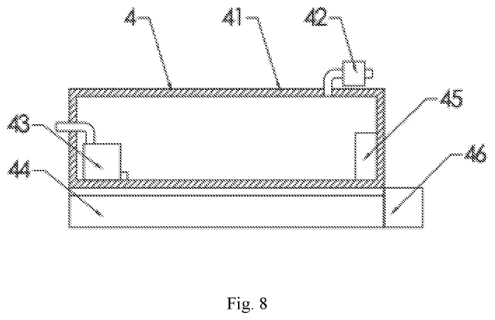

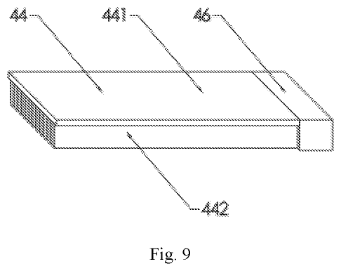

Now reference is made to FIGS. 1-9. An automatic smokeless oven with far infrared heating includes a seat body 1, a rotating device 2, a air treatment device 3 and a cooling device 4. The seat body 1 is provided with: a first cavity 100 having an opening at the top thereof, a second cavity 102 transversely arranged in the first cavity 100 and having the opening at the top thereof, and a third cavity 17 located at the bottom of the first cavity 100. An arc plate 11 is also provided above the seat body 1. The arc plate 11 is formed by extending an edge of the first cavity 100 towards the opening at the top of the first cavity 100. Baffles 13 are provided between two ends of the arc plate 11 in a first direction and the seat body 1. The first direction is a longitudinal direction of the seat body 1. An infrared heater 11, which is open to the first cavity 100, is provided at a side surface of the arc plate proximate to the first cavity 100 and is used for heating the first cavity 100, thus heating the food to be baked and reducing the oily smoke.

Further, the rotating device 2 is arranged in the second cavity 102 to drive the food to be baked to turn over, so as to realize the automatically turning over of the food. Further, the air treatment device 3 is disposed at the bottom of the first cavity 100, and is used for filtering air in the first cavity 100 to further reduce smoke emission. In addition, the cooling device 4 is arranged at the bottom of the first cavity 100 and communicated with the third cavity 17 for driving the cooling water to flow through the third cavity 17. In this way, a temperature of the bottom wall of the first cavity 100 can be reduced, and thus there is less probability for generating the oily smoke when grease, sauce and the like contact the bottom wall of the first cavity 100, due to a lower temperature.

Further, a flipper 114 is hinged at a side of the arc plate 11 away from the first cavity 100. The flipper 114, the arc plate 11 and the seat body 1 together enclose a fifth cavity 115. The arc plate 11 is provided with a plurality of first through holes 113 communicating the fifth cavity 115 with a space above the first cavity 100. The air treatment device 3 is communicated with the first through holes 113 and can filter the air in the first cavity 100 with the first through holes 113. In this way, the air is drawn above opening of the first cavity 100 and filtered, further reducing smoke emission.

Further, a fourth cavity 18 can be provided at a bottom of the third cavity 17. The air treatment device 3 is arranged in the fourth cavity 18 and includes an air pump 36 and a filter box 31. A sixth cavity 32 and a seventh cavity 33 which are sequentially communicated with each other are provided in the filter box 31. A first filter 34 is provided in the sixth cavity 32, and liquid filter media is filled in the sixth cavity 32. A second filter 35 connected with the sixth cavity 32 is provided in the seventh cavity 33. An air inlet and outlet of the air pump 36 are respectively communicated with the fifth cavity 115 and the first filter 34.

In addition, the first filter 34 and the second filter 35 can include a third casing 342 and a gas pipeline 341 which are sleeved with each other. An inner cavity of the third casing 342 is filled with activated carbon.

Further, the rotating device 2 includes a cover plate 21 with a U-shaped structure, a plurality of rollers 22, a transmission belt 23 and a motor 24 arranged in the second cavity 102. The cover plate 21 is fixedly arranged on an opening of the second cavity 102. The rollers 22 are rotatably connected to a side wall of the second cavity 102, and the roller 22 are in transmission connection with the motor 24. The transmission belt 23 is sleeved on the roller 22 and used for driving the food to be baked to turn over.

A supporting plate 12 corresponding to the second cavity 102 is provided in the first cavity 100. First serrations 121 are provided on a top of the supporting plate 12, and second serrations 212 are provided on a side of the cover plate 21 proximate to the supporting plate 12. Heights of the first serrations 121 are lower than those of the second serrations 212, and the first serrations and the second serrations are used for jointly bearing two ends of the food to be baked, so as to drive the food to turn over immediately after being placed.

Furthermore, a fourth cavity 18 is provided at a bottom of the third cavity 17, and the cooling device 4 is arranged in the fourth cavity 18 and includes a water tank 41 filled with water, an electromagnetic valve 42 communicated with an inner cavity of the water tank 41, a water pump 43 provided in the water tank 41, a water pressure sensor 45, a radiator 44, a fan 46, a controller 19 and a temperature sensor 181. An outlet of the water pump 43 and the electromagnetic valve 42 are respectively communicated with the third cavity 17. The radiator 44 includes a connecting plate 441 abutting against a bottom surface of the water tank 41 and a plurality of radiating fins 442 vertically connected with the connecting plate 441. The fan 46 is connected with the radiating fins 442.

It should be noted that the controller 19 is also electrically connected with the infrared heater 111, the motor 24, the air pump 36, the electromagnetic valve 42, the water pump 43, the water pressure sensor 45, the fan 46 and the temperature sensor 181 respectively.

In addition, both ends of the fourth cavity 18 are provided with openings, and mesh plates 14 are fixedly arranged on the openings to provide better heat dissipation conditions for the components in the fourth cavity 18 and ensure their normal operation.

Further, one side of the infrared heater 111 is hinged with the arc plate 11, and the other side of the infrared heater 111 is provided with a telescopic rod 112 hinged with the arc plate 11, so as to adjust an angle of the infrared heater 111.

Further, a plurality of hollow cylinders 101 are arranged on a bottom wall of the first cavity 100, and a flat plate 16 is arranged above the hollow cylinders 101. A connecting column 163 is arranged on the bottom of the flat plate 16 and sleeved on the hollow cylinder 101. A plurality of second through holes 162 communicated with the hollow cylinder 101 are arranged on the flat plate 16, and a plurality of grooves 161 communicated with the through holes are arranged on an upper end face of the flat plate 16. In this way, water on the flat plate 16 can flow into the first cavity 100 through the groove 161, the second through holes 162 and the hollow cylinder 101, and the flat plate 16 is tidy.

Further, a leg 15 is provided at a bottom of the seat body 1, and the leg 15 is any one of a telescopic rod 112, a hydraulic cylinder and an electric cylinder, or a combination thereof, so as to adjust a height of the oven.

In this automatic smokeless oven with far infrared heating, the seat body 1 is provided with a heating source at an upper end of the food to be baked so as to prevent grease, sauce and the like from contacting a heating source to generate oily smoke; the rotating device 2 can automatically turn over the food to be baked, which saves a manual turning of the food; the air treatment device 3 treats and discharges the generated oily smoke so as to protect the environment; the cooling device 4 cools the bottom of the oven, and thus there is less probability for generating the oily smoke when grease, sauce and the like contact the bottom wall of the oven, due to the lower temperature. This structure has advantages such as reasonable and simple structure, convenient use, high energy utilization rate, less generated oily smoke, high intelligent degree and, and effectively solves a problem that the oily smoke pollutes environment in existing ovens.

The above is only preferred embodiments of the present disclosure, and is not intended to limit the present disclosure. For those skilled in the art, the features in the above embodiments can be combined with each other and modification and variations can be made to the present disclosure without conflict.

I claim:

1. An automatic smokeless oven with far infrared heating, comprising a seat body (1), a rotating device (2), an air treatment device (3) and a cooling device (4); wherein
the seat body (1) is provided with: a first cavity (100) having an opening at a top thereof, a second cavity (102) transversely arranged in the first cavity (100) and having an opening at a top thereof, and a third cavity (17) located at a bottom of the first cavity (100);
an arc plate (11) is also provided above the seat body (1), the arc plate (11) is formed by extending an edge of the first cavity (100) towards the opening at the top of the first cavity (100), baffles (13) are provided between two ends of the arc plate (11) in a first direction and the seat body (1), the first direction being a longitudinal direction of the seat body (1);
an infrared heater (111), which is open to the first cavity (100), is provided at a side surface of the arc plate (11) proximate to the first cavity (100) and is used for heating the first cavity (100);
the rotating device (2) is arranged in the second cavity (102) to drive food to be baked to turn over;
the air treatment device (3) is arranged at the bottom of the first cavity (100) and used for filtering air in the first cavity (100); and
the cooling device (4) is arranged at the bottom of the first cavity (100) and communicated with the third cavity (17) for driving cooling water to flow through the third cavity (17).

2. The automatic smokeless oven with far infrared heating according to claim 1, wherein a flipper (114) is hinged at a side of the arc plate (11) away from the first cavity (100), the flipper (114), the arc plate (11) and the seat body (1) together enclose a fifth cavity (115), the arc plate (11) is provided with a plurality of first through holes (113) communicating the fifth cavity (115) with a space above the first cavity (100), and the air treatment device (3) is communicated with the first through holes (113) and filters the air in the first cavity (100) with the first through holes (113).

3. The automatic smokeless oven with far infrared heating according to claim 2, wherein a fourth cavity (18) is provided at a bottom of the third cavity (17), the air treatment device (3) is arranged in the fourth cavity (18) and comprises an air pump (36) and a filter box (31), wherein a sixth cavity (32) and a seventh cavity (33) which are sequentially communicated with each other are provided in the filter box (31), a first filter (34) is provided in the sixth cavity (32), and liquid filter media is filled in the sixth cavity (32), a second filter (35) connected with the sixth cavity (32) is provided in the seventh cavity (33), and an air inlet and outlet of the air pump (36) are respectively communicated with the fifth cavity (115) and the first filter (34).

4. The automatic smokeless oven with far infrared heating according to claim 3, wherein the first filter (34) and the second filter (35) comprise a third casing (342) and a gas pipeline (341) which are sleeved with each other, an inner cavity of the third casing (342) is filled with activated carbon.

5. The automatic smokeless oven with far infrared heating according to claim 1, wherein the rotating device (2) comprises a cover plate (21) with a U-shaped structure, a plurality of rollers (22), a transmission belt (23), and a motor (24) arranged in the second cavity (102); the cover plate (21) is fixedly arranged on an opening of the second cavity (102), the rollers (22) are rotatably connected to a side wall of the second cavity (102), the roller (22) are in transmission connection with the motor (24), and the transmission belt (23) is sleeved on the roller (22) and used for driving the food to be baked to turn over; and
a supporting plate (12) corresponding to the second cavity (102) is provided in the first cavity (100), first serrations (121) are provided on a top of the supporting plate (12), and second serrations (212) are provided on a side of the cover plate (21) proximate to the supporting plate (12), heights of the first serrations (121) being lower than heights of the second serrations (212), and the first serrations and the second serrations are used for jointly bearing two ends of the food to be baked.

6. The automatic smokeless oven with far infrared heating according to claim 1, wherein a fourth cavity (18) is provided at a bottom of the third cavity (17), and the cooling device (4) is arranged in the fourth cavity (18) and comprises a water tank (41) filled with water, an electromagnetic valve (42) communicated with an inner cavity of the water tank (41), a water pump (43) provided in the water tank (41), a water pressure sensor (45), a radiator (44), a fan (46), a controller (19) and a temperature sensor (181), wherein an outlet of the water pump (43) and the electromagnetic valve (42) are respectively communicated with the third cavity (17), the radiator (44) comprises a connecting plate (441) abutting against a bottom surface of the water tank (41) and a plurality of radiating fins (442) vertically connected with the connecting plate (441), and the fan (46) is connected with the radiating fins (442).

7. The automatic smokeless oven with far infrared heating according to claim 6, wherein both ends of the fourth cavity (18) are provided with openings, and mesh plates (14) are fixedly arranged on the openings.

8. The automatic smokeless oven with far infrared heating according to claim 1, wherein one side of the infrared heater (111) is hinged with the arc plate (11), and another side of the infrared heater (111) is provided with a telescopic rod (112) hinged with the arc plate (11).

9. The automatic smokeless oven with far infrared heating according to claim 1, wherein a plurality of hollow cylinders (101) are arranged on a bottom wall of the first cavity (100), and a flat plate (16) is arranged above the hollow cylinders (101);
a connecting column (163) is arranged on the bottom of the flat plate (16) and sleeved on the hollow cylinder (101), a plurality of second through holes (162) communicated with the hollow cylinder (101) are arranged on the flat plate (16), and a plurality of grooves (161) communicated with the through holes are arranged on an upper end face of the flat plate (16).

10. The automatic smokeless oven with far infrared heating according to claim 1, wherein a leg (15) is provided at a bottom of the seat body (1), the leg (15) being any one of a telescopic rod (112), a hydraulic cylinder and an electric cylinder, or a combination thereof.
